(19) United States
(12) Patent Application Publication
(10) Pub. No.: US 2011/0226992 A1
(43) Pub. Date: Sep. 22, 2011

(54) ORGANIC ELECTROLUMINESCENT MATERIAL COMPOSITIONS

(75) Inventors: Motohiro Takeshima, Chiba (JP); Kiyoshi Ikeda, Chiba (JP); Takayasu Sado, Chiba (JP); Tetsuya Inoue, Chiba (JP); Yoshiaki Obana, Tokyo (JP); Yukio Miyaki, Tokyo (JP); Keisuke Matsuo, Tokyo (JP); Yasunori Kijima, Tokyo (JP)

(73) Assignees: IDEMITSU KOSAN CO., LTD.; SONY CORPORATION

(21) Appl. No.: 13/119,602

(22) PCT Filed: Sep. 16, 2009
(86) PCT No.: PCT/JP2009/004647

§ 371 Date: Jun. 1, 2011

(30) Foreign Application Priority Data
Sep. 19, 2008 (JP) 2008-241349

(51) Int. Cl. C09K 11/06

(52) U.S. Cl. 252/301.16

(57) ABSTRACT

An organic electroluminescence material composition including an organic electroluminescence material and a solvent, the organic electroluminescence material being a naphthacene derivative, and the solvent being a solvent which is represented by the following formula (1).

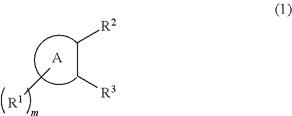

### TECHNICAL FIELD

The invention relates to a composition (coating liquid) containing an organic electroluminescence material. In particular, the invention relates to an organic electroluminescence material composition which can be preferably used in forming an organic electroluminescence material thin film by a coating method.

### BACKGROUND ART

An organic electroluminescence (hereinafter electroluminescence may appropriately be abbreviated as EL) is a self-emission device utilizing the principle that a fluorescent compound emits light by the recombination energy of holes injected from an anode and electrons injected from a cathode when an electric field is impressed.

As the emitting material constituting such an organic EL device, a low-molecular organic EL material is known.

As the low-molecular organic EL material, emitting materials such as a chelate complex such as a tris(8-quinolinol)aluminum complex, a coumalin complex, a tetraphenylbutadiene derivative, a bisstyryl arylene derivative and an oxadiazole derivative are known.

Since it is reported that they can emit light in the visible range from blue to red, development of a color display using it is expected.

For forming an organic EL material into a film, deposition has conventionally been used. Deposition has problems of complicated production processes, poor raw material utilization efficiency or the like. Therefore, in recent years, film formation of organic EL materials has come to be conducted by a coating method.

A coating method is generally used for forming a high-molecular organic EL material into a film. For example, a thin film of an organic EL material is formed by using an organic EL material dissolved in a solvent (Patent Document 1, for example). This coating method has advantages that a thin film of an organic EL material can be formed easily at a low cost and color coding can be conducted easily.

However, a high-molecular organic EL material is synthesized through a complicated process, and purification to a high purity is also difficult, and therefore, a high-molecular organic EL material improved in luminous efficiency, life, color purity or the like has not been known yet. In particular, a blue-emitting high-molecular organic EL material had poor performance as compared with a blue-emitting low-molecular organic EL material.

For the above-mentioned reasons, an attempt has been made to form into a film a low-molecular organic EL material by a coating method.

When forming a thin film of an organic EL material by a coating method, an organic EL material is required to be dissolved in a solvent. However, a low-molecular organic EL material normally has a low solubility for a solvent such as toluene, xylene and tetraline which can be used for a high-molecular EL material (see Patent Document 2, for example), and hence, it was impossible to prepare a coating liquid at a high concentration.

Patent Documents 3 and 4 disclose that, in forming an organic EL material into a film, cyclohexylbenzene, isopropylbiphenyl, 2,3-dihydrobenzofurane or the like is used as a solvent for a high-molecular organic EL material. However, the above-mentioned solvents are suited for pattern coating by the ink-jet method.

Patent Document 5 discloses a coating method using a low-molecular organic EL material. However, by this coating method, the solubility of a low-molecular EL material is insufficient, and the device performance obtained (luminous efficiency, lifetime, color purity or the like) was also insufficient.

### RELATED ART DOCUMENTS

### Patent Documents

Patent Document 1: JP-A-2003-229256
Patent Document 2: WO2000/059267
Patent Document 3: JP-A-2002-371196
Patent Document 4: JP-A-2004-179144
Patent Document 5: JP-A-2006-190759

### SUMMARY OF THE INVENTION

The invention is aimed at providing an organic EL material composition capable of forming an organic EL thin film by a coating method which can form a thin film easily at a low cost and capable of forming a homogenous coating film having excellent long-term storage stability.

The inventors have found that, in an organic EL material composition, a naphthacene derivative can be dissolved at a desired concentration in a solvent having a ring structure as a main skeleton, in which a substituent has been introduced into each of the first and second positions thereof or each of two adjacent elements in the ring skeleton. The inventors have also found that a thin film obtained by using an organic EL material composition containing the above-mentioned solvent and a naphthacene derivative has a high uniformity.

According to the invention, the following organic EL material composition or the like are provided.

1. An organic electroluminescence material composition comprising an organic electroluminescence material and a solvent,

the organic electroluminescence material being a naphthacene derivative, and

the solvent being a solvent which is represented by the following formula (1):

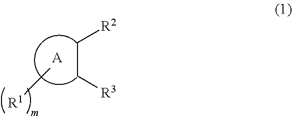

wherein the ring A is one selected from the group consisting of an aliphatic ring having 4 to 8 carbon atoms, an aromatic ring having 4 to 8 carbon atoms, a nitrogen-containing aliphatic ring having 4 to 8 carbon atoms, an oxygen-containing aliphatic ring having 4 to 8 carbon atoms and a sulfur-containing aliphatic ring having 4 to 8 carbon atoms;

R¹ is a substituent for the ring A, and is a hydrogen atom, a substituted or unsubstituted alkyl group having 1 to 10 carbon atoms, a substituted or unsubstituted cycloalkyl group, a substituted or unsubstituted alkoxy group having 1 to 10 carbon atoms, a substituted or unsubstituted aralkyl group having 6 to 10 carbon atoms, a substituted or unsubstituted aryloxy group having 5 to 10 atoms that form a ring (hereinafter referred to as “ring atoms”), a substituted or unsubstituted arylthio group having 5 to 20 ring atoms, a substituted or unsubstituted alkoxycarbonyl group having 1 to 10 carbon atoms, a substituted or unsubstituted silyl group, a carboxy group, a halogen atom, a cyano group, a nitro group or a hydroxyl group;

m is an integer of 1 to 6, and when m is an integer of 2 or more, plural R¹s may be the same or different;

R² and R³ are substituents bonded to adjacent carbon atoms on the ring A, and are independently an alkyl group having 1 to 10 carbon atoms, a substituted or unsubstituted alkenyl group having 1 to 10 carbon atoms, a substituted or unsubstituted cycloalkyl group, a substituted or unsubstituted cycloalkenyl group, a substituted or unsubstituted alkoxy group having 1 to 10 carbon atoms, a substituted or unsubstituted aralkyl group having 6 to 10 carbon atoms, a substituted or unsubstituted aryloxy group having 5 to 10 ring atoms, a substituted or unsubstituted arylthio group having 5 to 20 ring atoms, a substituted or unsubstituted alkoxycarbonyl group having 1 to 10 carbon atoms, a substituted or unsubstituted silyl group, a carboxyl group, a halogen atom, a cyano group, a nitro group, or a hydroxyl group; and

R² and R³ may be bonded to each other to form a ring.

2. The organic electroluminescence material composition according to 1, wherein the ring A is a hydrocarbon ring having 6 carbon atoms.
3. The organic electroluminescence material composition according to 1 or 2, wherein R² and R³ of the solvent represented by the formula (1) are bonded to each other to form a ring; and

the substituent formed by bonding of R² and R³ is one of

a substituted or unsubstituted cycloalkylene group having 4 to 10 carbon atoms, a substituted or unsubstituted cycloalkenylene group having 4 to 10 carbon atoms, a substituted or unsubstituted cyclooxyalkylene group having 3 to 10 carbon atoms, a substituted or unsubstituted cyclooxyalkenylene group having 3 to 10 carbon atoms, a substituted or unsubstituted cyclothioalkylene group having 3 to 10 carbon atoms, a substituted or unsubstituted cyclothioalkenylene group having 3 to 10 carbon atoms, a substituted or unsubstituted cycloazaalkylene group having 3 to 10 carbon atoms, a substituted or unsubstituted cycloazaalkenylene group having 3 to 10 carbon atoms, a substituted or unsubstituted arylene group having 5 to 10 ring atoms, a substituted or unsubstituted oxyarylene group having 4 to 10 ring atoms, a substituted or unsubstituted thioarylene group having 4 to 10 ring atoms, and a substituted or unsubstituted azaarylene group having 3 to 10 ring atoms.
4. The organic electroluminescence material composition according to one of 1 to 3, wherein the naphthacene derivative has a molecular weight of 4000 or less.
5. The organic electroluminescence material composition according to one of 1 to 4, wherein the naphthacene derivative is a compound represented by the following formula (2):

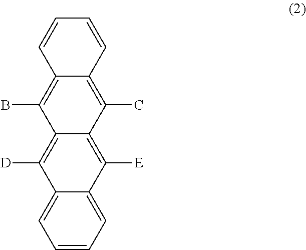

wherein B, C, D and E are independently a hydrogen atom, a substituted or unsubstituted aromatic group having 6 to 20 carbon atoms or a substituted or unsubstituted fused aromatic ring group having 10 to 20 carbon atoms.
6. The organic electroluminescence material composition according to 5, wherein at least one of B, C, D and E of the compound represented by the formula (2) is a substituent represented by the formula (3):

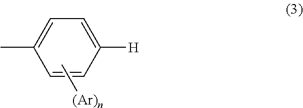

wherein Ar is a substituted or unsubstituted phenyl group, a substituted or unsubstituted naphthyl group or a substituted or unsubstituted biphenyl group;

n is an integer of 1 to 4, and when n is an integer of 2 or more, plural Ars may be the same or different; and

H is a hydrogen atom.

7. The organic electroluminescence material composition according to one of 1 to 6 which further comprises one or more dopants.
8. The organic electroluminescence material composition according to 7, wherein a dopant is an indenoperylene derivative represented by the following formula (4):

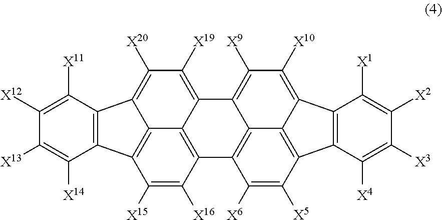

wherein X¹ to X⁶, X⁹, X¹⁰, X¹¹ to X¹⁶, X¹⁹ and X²⁰ are independently hydrogen, halogen, an alkyl group, an alkoxy group, an alkylthio group, an alkenyl group, an alkenyloxy group, an alkenylthio group, an aromatic ring-containing alkyl group, an aromatic ring-containing alkyloxy group, an aromatic ring-containing alkylthio group, an aromatic ring group, an aromatic heterocyclic group, an aromatic ring-oxy group, an aromatic ring-thio group, an aromatic ring alkenyl group, an alkenyl aromatic ring group, an amino group, a carbazolyl group, a cyano group, a hydroxy group, —COOR^{1′} (R^{1′} is hydrogen, an alkyl group, an alkenyl group, an aromatic ring-containing alkyl group or an aromatic ring), —COR^{2′} (R^{2′} is hydrogen, an alkyl group, an alkenyl group, an aromatic ring-containing alkyl group, an aromatic ring group or an amino group), or —OCOR^{3′} (R^{3′} is an alkyl group, an alkenyl group, an aromatic ring-containing alkyl group or an aromatic ring group);

adjacent substituents of X¹ to X⁶, X⁹, X¹⁰, X¹¹ to X¹⁶, X¹⁹ and X²⁰ may be bonded together to form a ring; and

X⁹, compounds in which all of X¹ to X⁶, X¹⁰, X¹¹ to X¹⁶, X¹⁹ and X²⁰ are hydrogen are excluded.

9. The organic electroluminescence material composition according to 8, wherein the indenoperylene derivative represented by the formula (4) is an indenoperylene derivative represented by the following formula (5):

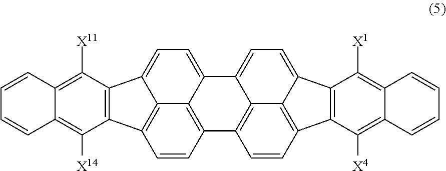

wherein X¹, X⁴, X¹¹ and X¹⁴ are the same as those in the formula (4).
10. The organic electroluminescence material composition according to 7, wherein a dopant is a compound having a pyrromethene skeleton represented by the following formula (6) or a metal complex of at least one metal selected from the group consisting of boron, beryllium, magnesium, chromium, iron, cobalt, nickel, copper, zinc and platinum and a compound represented by the formula (6):

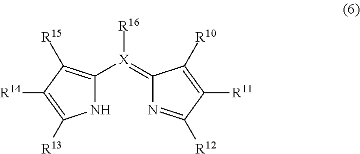

wherein R¹⁰ to R¹⁶ are independently hydrogen, an alkyl group having 1 to 20 carbon atoms, a cycloalkyl group having 1 to 20 carbon atoms, an aralkyl group having 1 to 20 carbon atoms, an alkenyl group having 1 to 20 carbon atoms, a cycloalkenyl group having 1 to 20 carbon atoms, an alkynyl group having 1 to 20 carbon atoms, a hydroxy group, a mercapto group having 1 to 20 carbon atoms, an alkoxy group having 1 to 20 carbon atoms, an alkylthio group having 1 to 20 carbon atoms, an arylether group having 1 to 20 carbon atoms, an arylthioether group having 1 to 20 carbon atoms, an aryl group having 1 to 20 carbon atoms, a heterocyclic group having 1 to 20 carbon atoms, halogen, a haloalkyl group having 1 to 20 carbon atoms, a haloalkenyl group having 1 to 20 carbon atoms, a haloalkynyl group having 1 to 20 carbon atoms, a cyano group, an aldehyde group having 1 to 20 carbon atoms, a carbonyl group having 1 to 20 carbon atoms, a carboxyl group having 1 to 20 carbon atoms, an ester group having 1 to 20 carbon atoms, a carbamoyl group having 1 to 20 carbon atoms, an amino group, a nitro group, a silyl group or a siloxanyl group, R¹⁰ to R¹⁶ may be bonded to adjacent substituents to form a fused ring or an aliphatic ring;

at least one of R¹⁰ to R¹⁶ contains an aromatic ring or forms a fused ring with an adjacent substituent; and

X is carbon or nitrogen, provided that if X is nitrogen, no R¹⁶ is present.

11. The organic electroluminescence material composition according to 10, wherein the metal complex is a boron complex represented by the following formula (7) or (8):

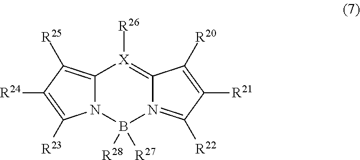

wherein R²⁰ to R²⁶ and X are the same as R¹⁰ to R¹⁶ and X in the formula (6); and

R²⁷ and R²⁸ are independently a halogen atom, a hydrogen atom, an alkyl group, an aryl group, a heterocyclic group, an alkoxy group, an aralkyl group, a carbocyclic aryl group or a heterocyclic aryl group.

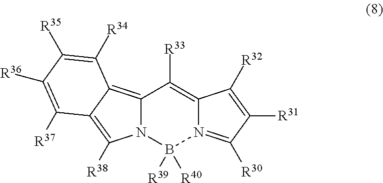

wherein R³⁰ to R³² and R³⁴ to R³⁸ are independently a hydrogen atom, an alkyl group, an alkoxyalkyl group, an alkoxy group, an alkoxyalkoxy group, an aryloxy group, an acyl group, an alkoxycarbonyl group, a dialkylaminocarbonyl group, an alkylcarbonylamino group, an arylcarbonylamino group, an arylaminocarbonyl group, an aryloxycarbonyl group, an aralkyl group, a carbocyclic aryl group, an alkenyloxycarbonyl group, an aralkyloxycarbonyl group, an alkoxycarbonylalkoxycarbonyl group, an alkylcarbonylalkoxycarbonyl group, a di(alkoxyalkyl)aminocarbonyl group or an alkenyl group;

R³³ is a hydrogen atom, a cyano group, an alkyl group, an aralkyl group, a carbocyclic aryl group, a heterocyclic aryl group or an alkenyl group; and

R³⁹ and R⁴⁰ are independently fluorine, an alkyl group, an alkoxy group, an aralkyl group, a carbocyclic aryl group or a heterocyclic aryl group, and at least one of R³⁹ and R⁴⁰ is fluorine or an alkoxy group.

12. A method for forming a thin film of an organic electroluminescence material which comprises applying on a base the organic electroluminescence material composition according to one of 1 to 11; and removing a solvent from the organic electroluminescence material composition on the base to form a thin film of an organic electroluminescence material.
13. A thin film of an organic electroluminescence material obtained by using the organic electroluminescence material composition according to one of 1 to 11.
14. An organic electroluminescence device which comprises the organic electroluminescence material thin film according to 13.

According to the invention, an organic EL material composition capable of forming an organic EL thin film by a coating method which can form a thin film easily at a low cost easily at a low cost, and has improved long-term storage stability and a desired concentration can be provided.

Further, according to the invention, an organic EL material thin film which is uniform and has high flatness can be provided.

### MODE FOR CARRYING OUT THE INVENTION

The organic EL material composition of the invention comprises an organic electroluminescence material and a solvent, the organic electroluminescence material being a naphthacene derivative and the solvent being a solvent represented by the following formula (1):

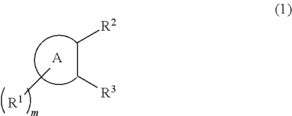

wherein the ring A is one selected from the group consisting of an aliphatic ring having 4 to 8 carbon atoms, an aromatic ring having 4 to 8 carbon atoms, a nitrogen-containing aliphatic ring having 4 to 8 carbon atoms, an oxygen-containing aliphatic ring having 4 to 8 carbon atoms and a sulfur-containing aliphatic ring having 4 to 8 carbon atoms;

R¹ is a substituent for the ring A, and is a hydrogen atom, a substituted or unsubstituted alkyl group having 1 to 10 carbon atoms, a substituted or unsubstituted cycloalkyl group, a substituted or unsubstituted alkoxy group having 1 to 10 carbon atoms, a substituted or unsubstituted aralkyl group having 6 to 10 carbon atoms, a substituted or unsubstituted aryloxy group having 5 to 10 ring atoms, a substituted or unsubstituted arylthio group having 5 to 20 ring atoms, a substituted or unsubstituted alkoxycarbonyl group having 1 to 10 carbon atoms, a substituted or unsubstituted silyl group, a carboxy group, a halogen atom, a cyano group, a nitro group or a hydroxyl group;

m is an integer of 1 to 6, and when m is an integer of 2 or more, plural R¹s may be the same or different;

R² and R³ are substituents bonded to adjacent carbon atoms on the ring A, and are independently an alkyl group having 1 to 10 carbon atoms, a substituted or unsubstituted alkenyl group having 1 to 10 carbon atoms, a substituted or unsubstituted cycloalkyl group, a substituted or unsubstituted cycloalkenyl group, a substituted or unsubstituted alkoxy group having 1 to 10 carbon atoms, a substituted or unsubstituted aralkyl group having 6 to 10 carbon atoms, a substituted or unsubstituted aryloxy group having 5 to 10 ring atoms, a substituted or unsubstituted arylthio group having 5 to 20 ring atoms, a substituted or unsubstituted alkoxycarbonyl group having 1 to 10 carbon atoms, a substituted or unsubstituted silyl group, a carboxyl group, a halogen atom, a cyano group, a nitro group, or hydroxyl group; and

R² and R³ may be bonded to each other to form a ring.

In the formula (1), the ring A is one selected from the group consisting of an aliphatic ring having 4 to 8 carbon atoms, an aromatic ring having 4 to 8 carbon atoms, a nitrogen-containing aliphatic ring having 4 to 8 carbon atoms, an oxygen-containing aliphatic ring having 4 to 8 carbon atoms and a sulfur-containing aliphatic ring having 4 to 8 carbon atoms.

The ring A is preferably a hydrocarbon ring having 6 carbon atoms (aliphatic six-membered ring, aromatic six-membered ring). Specific examples thereof include benzene, cyclohexane, cyclohexene and cyclohexadiene.

In the formula (1), R¹ is a substituent for the ring A.

R¹ is a hydrogen atom, a substituted or unsubstituted alkyl group having 1 to 10 carbon atoms, a substituted or unsubstituted cycloalkyl group, a substituted or unsubstituted alkoxy group having 1 to 10 carbon atoms, a substituted or unsubstituted aralkyl group having 6 to 10 carbon atoms, a substituted or unsubstituted aryloxy group having 5 to 10 ring atoms, a substituted or unsubstituted arylthio group having 5 to 20 ring atoms, a substituted or unsubstituted alkoxycarbonyl group having 1 to 10 carbon atoms, a substituted or unsubstituted silyl group, a carboxyl group, a halogen atom, a cyano group, a nitro group or a hydroxyl group.

When the ring A is substituted with a plurality of R¹ (when m is 2 or more), plural R¹s may be the same or different.

As the alkyl group having 1 to 10 carbon atoms, a methyl group, an ethyl group, a t-butyl group, a propyl group, an isopropyl group, an n-butyl group, an s-butyl group, an isobutyl group, an n-pentyl group, an n-hexyl group, an n-heptyl group, an n-octyl group, or the like can be given, for example.

As the cycloalkyl group, a cyclobutyl group, a cyclopentyl group, a cyclohexyl group, a cycloheptyl group, a cyclooctyl group, or the like can be given, for example.

As an alkoxy group having 1 to 10 carbon atoms, a methoxy group, an ethoxy group, a propoxy group, a butoxy group, a pentyloxy group, a hexyloxy group, a heptyloxy group, an octyloxy group, or the like can be given, for example.

As the aralkyl group having 6 to 10 carbon atoms, a benzyl group, a phenylethyl group, a phenylpropyl group, a phenylbutyl group, an indenylmethyl group, an indanylmethyl group, a naphthylmethyl group, or the like are preferable, for example.

As the substituted or unsubstituted aryloxy group having 5 to 10 ring atoms, a phenoxy group, a benzyloxy group, a methylphenoxy group, a dimethylphenoxy group, an ethylphenoxy group, a trimethylphenoxy group, a propylphenoxy group, a tetramethylphenoxy group, a diethylphenoxy group, a butylphenoxy group, an oxynaphthyl group, an oxyindanyl group, an oxyindenyl group, or the like are preferable, for example.

As the substituted or unsubstituted arylthio group having 5 to 20 ring atoms, a thiophenyl group, a thiobenzyl group, a thiomethylphenyl group, a thiodimethylphenyl group, a thioethylphenyl group, a thiotrimethylphenyl group, a thiopropylphenyl group, a thiotetramethylphenyl group, a thiodiethylphenyl group, a thiobutylphenyl group, a thionaphthyl group, a thioindenyl group, a thioindanyl group, or the like are preferable, for example.

As the alkoxycarbonyl group having 1 to 10 carbon atoms, a methoxycarbonyl group, an ethoxycarbonyl group, a propoxycarbonyl group, a butoxycarbonyl group, a pentyloxycarbonyl group, a hexyloxycarbonyl group, a heptyloxycarbonyl group, an octyloxycarbonyl group, a nonyloxycarbonyl group, or the like are preferable, for example.

As the substituted or unsubstituted silyl group, a trimethylsilyl group, a trimethoxysilyl group, a triethylsilyl group, a triethoxysilyl group, a chlorodimethylsilyl group, a triisopropylsilyl group, a triisopropoxysilyl group, or the like are preferable, for example.

If the above-mentioned group has a substituent, as the substituent, a substituted or unsubstituted alkyl group having 1 to 10 carbon atoms, a substituted or unsubstituted cycloalkyl group, a substituted or unsubstituted alkoxy group having 1 to 10 carbon atoms, a substituted or unsubstituted aralkyl group having 6 to 10 carbon atoms, a substituted or unsubstituted aryloxy group having 6 to 10 ring atoms, a substituted or unsubstituted arylthio group having 6 to 10 ring atoms, a substituted or unsubstituted alkoxycarbonyl group having 1 to 10 carbon atoms, a substituted or unsubstituted silyl group, a carboxyl group, a halogen atom, a cyano group, a nitro group, or a hydroxyl group, as mentioned above, can be given.

In the formula (1), R² and R³ are substituents bonded to adjacent carbon atoms on the ring A, which are independently a substituted or unsubstituted alkyl group having 1 to 10 carbon atoms, a substituted or unsubstituted alkenyl group having 1 to 10 carbon atoms, a substituted or unsubstituted cycloalkyl group, a substituted or unsubstituted cycloalkenyl group, a substituted or unsubstituted alkoxy group having 1 to 10 carbon atoms, a substituted or unsubstituted aralkyl group having 6 to 10 carbon atoms, a substituted or unsubstituted aryloxy group having 5 to 10 ring atoms, a substituted or unsubstituted arylthio group having 5 to 20 ring atoms, a substituted or unsubstituted alkoxycarbonyl group having 1 to 10 carbon atoms, a substituted or unsubstituted silyl group, a carboxyl group, a halogen atom, a cyano group, a nitro group, or a hydroxyl group.

As the alkenyl group having 1 to 10 carbon atoms, an ethenyl group, a propenyl group, a butenyl group, a pentenyl group, a pentadienyl group, a hexenyl group, a hexadienyl group, a heptenyl group, an octenyl group, an octadienyl group, a 2-ethylhexenyl group, a decenyl group, or the like are preferable.

As the cycloalkenyl group, a cyclobutenyl group, a cyclopentenyl group, a cyclopentadienyl group, a cyclohexenyl group, a cyclohexadienyl group, a cycloheptenyl group, a cyclooctenyl group, a cyclooctadienyl group, or the like are preferable.

Other examples of R² and R³ and the substituents thereof are the same as the examples of R¹.

R² and R³ may be bonded to each other to form a ring. The ring formed by the bonding of R² and R³ is preferably a substituted or unsubstituted hydrocarbon ring having 4 to 10 carbon atoms or a substituted or unsubstituted heterocyclic ring having 2 to 10 carbon atoms.

Specific examples of the substituent formed by the bonding of R² and R³ include a substituted or unsubstituted cycloalkylene group having 4 to 10 carbon atoms, a substituted or unsubstituted cycloalkenylene group having 4 to 10 carbon atoms, a substituted or unsubstituted cyclooxyalkylene group having 3 to 10 carbon atoms, a substituted or unsubstituted cyclooxyalkenylene group having 3 to 10 carbon atoms, a substituted or unsubstituted cyclothioalkylene group having 3 to 10 carbon atoms, a substituted or unsubstituted cyclothioalkenylene group having 3 to 10 carbon atoms, a substituted or unsubstituted cycloazaalkylene group having 3 to 10 carbon atoms, a substituted or unsubstituted cycloazaalkenylene group having 3 to 10 carbon atoms, a substituted or unsubstituted arylene group having 5 to 10 ring atoms, a substituted or unsubstituted oxyarylene group having 4 to 10 ring atoms, a substituted or unsubstituted thioarylene group having 4 to 10 ring atoms and a substituted or unsubstituted azaarylene group having 3 to 10 ring atoms.

A ring is formed by the above-mentioned substituent formed by the bonding of R² and R³ and two carbon atoms on the ring A with which R² and R³ are substituted.

Specific examples of the solvent represented by the formula (1) include indene, indane, 2-methylanisole, 3a,4,7,7a-tetra-hydroindene, 2-ethyltoluene, 1,2-methylenedioxybenzene, o-xylene, 2,3-dihydrobenzofuran, 1,2,4-trimethylbenzene, 1,2,3-trimethylbenzene, 2-ethylanisole, 2,5-dimethylanisole, 2,3-dihydro-2-methylbenzofuran, 1,2,3,5-tetramethylbenzene, 1,2-dihydronaphthalene, 1,2,3,4-tetrahydronaphthalene, tricyclo[6.2.1.0(2,7)]undeca-4-ene, 4-tert-butyl-o-xylene, 1,4-dihydronaphthalene, 2,5-dimethoxy toluene, 1-acetyl-1,2,3,4-tetra-hydroquinoline, N-methylindole, 1-methylnapthalene, 2-isopropyl naphthalene, dimethyl phthalate, 2,6-dimethylanisole, 2-ethylphenyl acetate, o-tolyl acetate, 3,4-dihydro-1H-2-benzopyrane, 6-methoxy-1,2,3,4-tetrahydronaphthalene, 5,6,7,8-tetrahydroisoquinoline, 1,2-epoxycyclooctane, 1,2-epoxycyclohexane, 1,2-epoxycyclopentane, 2-methylcyclohexanol, tetrahydrodicyclopentadiene, 2,3-diemthylthiophene, 2,3-dimethylfuran or the like can be given;

The solvent for the organic EL material composition of the invention (hereinafter often referred to simply as the solvent of the invention) has a ring skeleton having 4 to 8 carbon atoms as a basic skeleton, and has a substituent in each of the first and second positions thereof or in each of two adjacent elements in the ring skeleton. Due to the above-mentioned structure, the solubility of the naphthalene derivative for the solvent of the invention can be enhanced, whereby an organic EL material composition with a desired concentration can be obtained.

No particular restrictions are imposed on a naphthacene derivative of the organic EL material composition of the invention (hereinafter often simply referred to as the naphthacene derivative of the invention) as long as it is a compound which can be used as an organic EL material. The naphthacene derivative preferably has a molecular weight of 4000 or less.

The naphthacene derivative of the invention is preferably a compound represented by the following formula (2) which can function as a host material of an emitting layer.

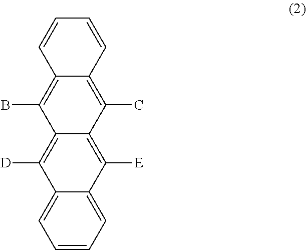

wherein B, C, D and E are independently a hydrogen atom, a substituted or unsubstituted aromatic group having 6 to 20 carbon atoms, a substituted or unsubstituted fused aromatic group having 10 to 20 carbon atoms or a substituted or unsubstituted heteroaryl group having 5 to 20 ring atoms.

The compound represented by the formula (2) is a compound in which at least one of B, C, D and E is a substituent represented by the following formula (3):

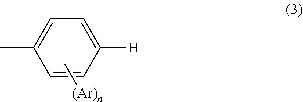

wherein Ar is a substituted or unsubstituted phenyl group, a substituted or unsubstituted naphthyl group or a substituted or unsubstituted biphenyl group;

n is an integer of 1 to 4, when n is an integer of 2 or more, plural Ars may be the same or different; and

H is a hydrogen atom.

Specific examples of the naphthacene derivative of the invention are shown below.

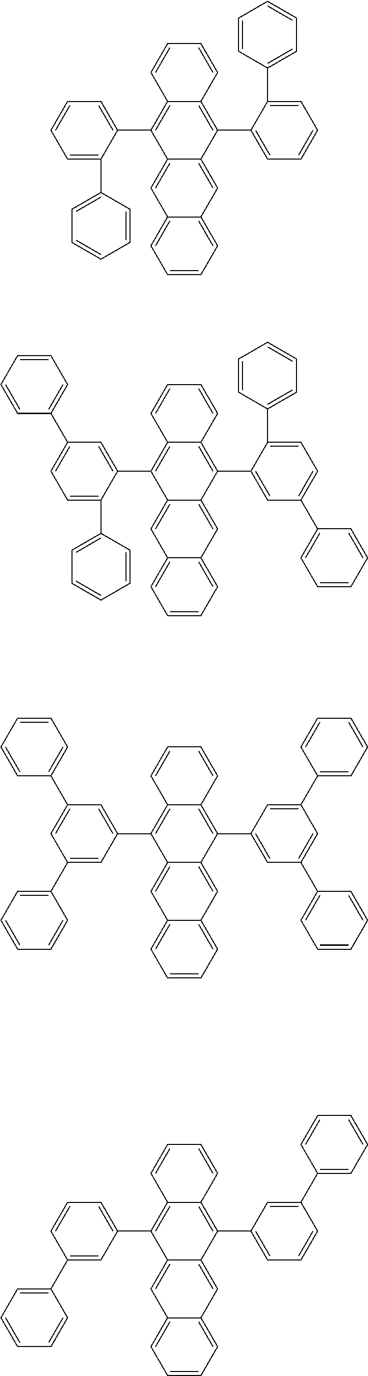

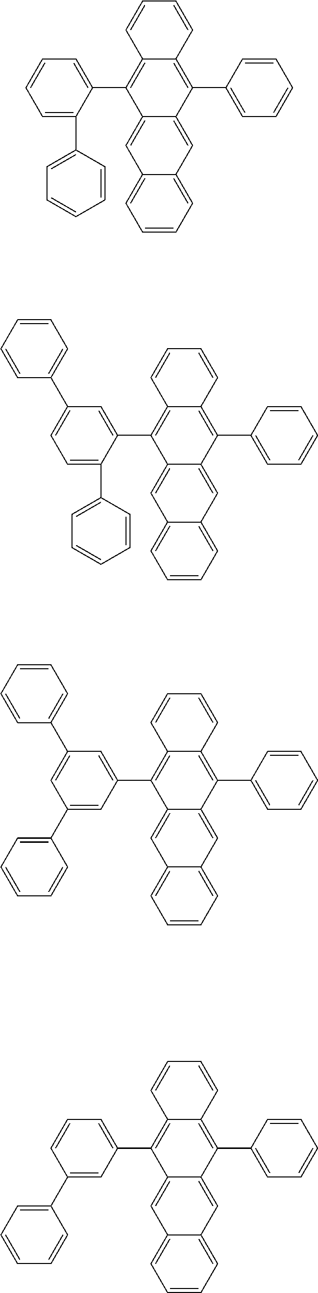

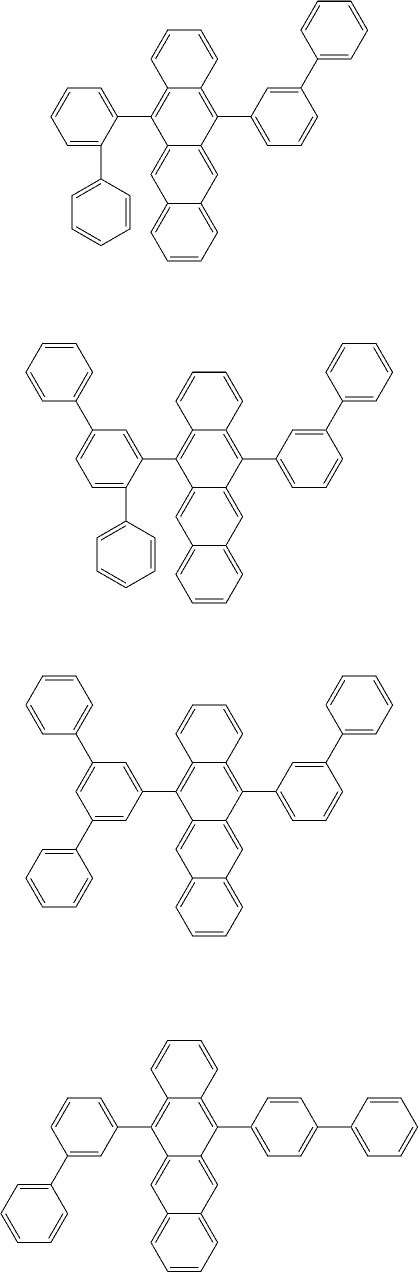

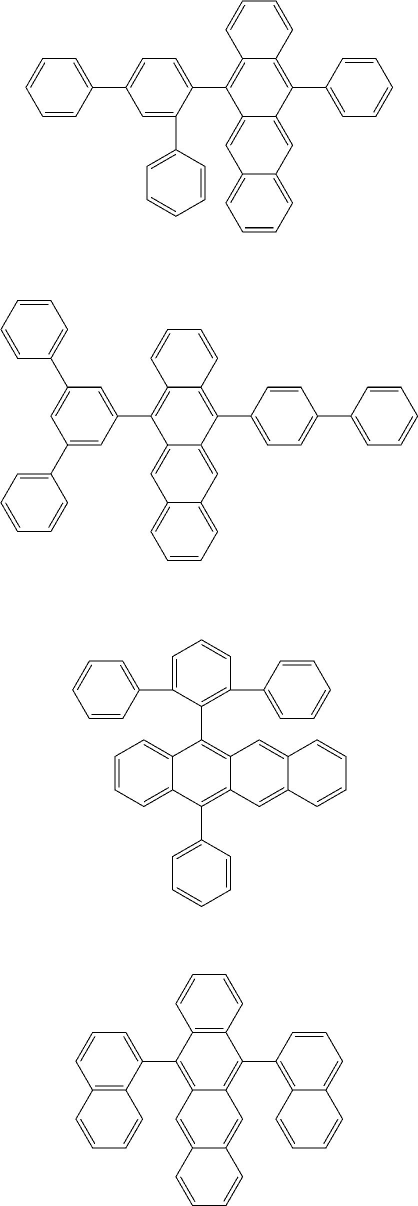

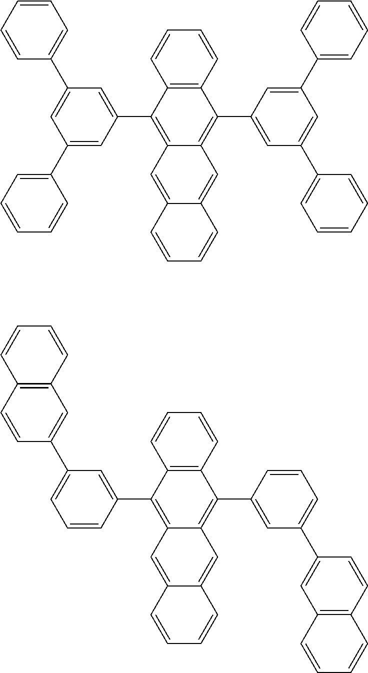

The naphthacene derivative represented by the formula (2) has improved performance as a red emitting organic EL material. Therefore, an organic EL thin film obtained by forming into a film the organic EL material composition of the invention by a coating method has improved performance in respect of luminous efficiency, lifetime, color purity or the like.

In the organic EL material composition of the invention, the content of the naphthacene derivative is preferably 0.01 wt % or more, more preferably 0.05 wt % or more, of the total amount of the organic EL material composition. If the content of the naphthacene derivative is 0.05 wt % or more, formation of an organic EL material thin film with a film thickness of 50 nm or more becomes possible. If the content of the naphthacene derivative is less than 0.01 wt %, formation of an organic EL material thin film having a uniform film thickness may become difficult.

In the organic EL material composition of the invention, the solvent of the invention may be used singly or in a mixture of two or more. Further, the organic EL material composition of the invention may contain other solvents than those according to the invention (other solvents). In the case of a mixed solvent of the solvent of the invention and other solvents, the content of the solvent of the invention relative to the total amount of the mixed solvent may be preferably 20 wt % or more, 50% or more, or 75% or more. In order to utilize the effects of the solvent of the invention, it is preferred that the content of the solvent of the invention be 50 wt % or more.

The “pot life” can be given as one of the criteria for evaluating an organic EL material composition. The “pot life” is a criterion to evaluate usable days of a composition by counting the days passed until precipitates are generated in a composition which is a homogeneous solution immediately after the preparation. In respect of long-term storage stability, a longer pot life is better. The pot life of the organic EL material composition of the invention is preferably two weeks or more, more preferably one month or more.

The organic EL material composition of the invention has a long pot life, and a change with the passage of time of the physical properties thereof is significantly small. Therefore, stable production of an organic EL device becomes possible, and variations in device performance of the resulting organic EL devices can be reduced.

It is preferred that the organic EL material composition of the invention further contain a dopant.

As the dopant contained in the organic EL material composition of the invention (hereinafter often referred to simply as the dopant of the invention), an indenoperylene derivative represented by the following formula (4) can be preferably (liven.

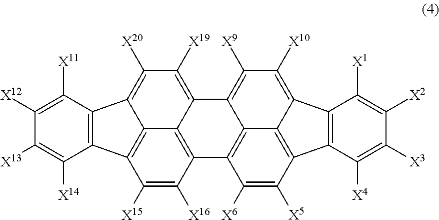

wherein X¹ to X⁶, X⁹, X¹⁰, X¹¹ to X¹⁶ and X¹⁹ and X²⁰ are independently hydrogen, halogen, an alkyl group, an alkoxy group, an alkylthio group, an alkenyl group, an alkenyloxy group, an alkenylthio group, an aromatic ring-containing alkyl group, an aromatic ring-containing alkyloxy group, an aromatic ring-containing alkylthio group, an aromatic ring group, an aromatic heterocyclic group, an aromatic ring-oxy group, an aromatic ring-thio group, an aromatic ring alkenyl group, an alkenyl aromatic ring group, an amino group, a carbazolyl group, a cyano group, a hydroxy group, —COOR^{1′} (R^{1′} is hydrogen, an alkyl group, an alkenyl group, an aromatic ring-containing alkyl group or an aromatic ring group), —COR^{2′} (R^{2′} is hydrogen, an alkyl group, an alkenyl group, an aromatic ring-containing alkyl group, an aromatic ring group or an amino group), or —OCOR^{3′} (R^{3′} is an alkyl group, an alkenyl group, an aromatic ring-containing alkyl group or an aromatic ring group);

adjacent substituents of X¹ to X⁶, X⁹, X¹⁰, X¹¹ to X¹⁶, X¹⁹ and X²⁰ may be bonded together to form a ring; and

compounds in which all of X¹ to X⁶, X⁹, X¹⁰, X¹¹ to X¹⁶, X¹⁹ and X²⁰ are hydrogen are excluded.

The indenoperylene derivative represented by the formula (4) is preferably an indenoperylene derivative represented by the following formula (5):

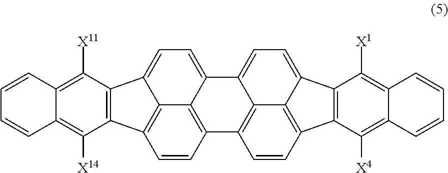

wherein X¹, X⁴, X¹¹ and X¹⁴ are the same as those in the formula (4).

In the indenoperylene derivative represented by the formula (5), it is preferred that X¹, X⁴, X¹¹ and X¹⁴ be an aromatic ring group. Preferable aromatic ring groups include a phenyl group, an orthobiphenyl group, a metabiphenyl group and a naphthyl group, with a phenyl group and an orthobiphenyl group being further preferable.

As the indenoperylene derivative represented by the formula (4), a dibenzotetraphenyl periflanthene derivative or the like can be preferably given.

As the dopant of the invention, a compound having a pyrromethene skeleton represented by the following formula (6) or a metal complex of at least one metal selected from the group consisting of boron, beryllium, magnesium, chromium, iron, cobalt, nickel, copper, zinc and platinum and the compound represented by the formula (6) can be preferably given.

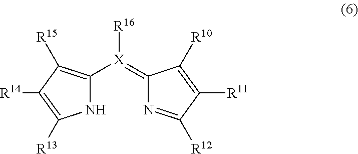

wherein R¹⁰ to R¹⁶ are independently hydrogen, an alkyl group having 1 to 20 carbon atoms, a cycloalkyl group having 1 to 20 carbon atoms, an aralkyl group having 1 to 20 carbon atoms, an alkenyl group having 1 to 20 carbon atoms, a cycloalkenyl group having 1 to 20 carbon atoms, an alkynyl group having 1 to 20 carbon atoms, a hydroxy group, a mercapto group having 1 to 20 carbon atoms, an alkoxy group having 1 to 20 carbon atoms, an alkylthio group having 1 to 20 carbon atoms, an arylether group having 1 to 20 carbon atoms that form a ring (hereinafter referred to as “ring carbon atoms”), an arylthioether group having 1 to 20 ring carbon atoms, an aryl group having 1 to 20 carbon atoms, a heterocyclic group having 1 to 20 carbon atoms, halogen, a haloalkyl group having 1 to 20 carbon atoms, a haloalkenyl group having 1 to 20 carbon atoms, a haloalkynyl group having 1 to 20 carbon atoms, a cyano group, an aldehyde group having 1 to 20 carbon atoms, a carbonyl group having 1 to 20 carbon atoms, a carboxyl group having 1 to 20 carbon atoms, an ester group having 1 to 20 carbon atoms, a carbamoyl group having 1 to 20 carbon atoms, an amino group, a nitro group, a silyl group or a siloxanyl group, R¹⁰ to R¹⁶ may be bonded to an adjacent substituent to form a fused ring or an aliphatic ring.

At least one of R¹⁰ to R¹⁶ contains an aromatic ring or forms a fused ring with an adjacent substituent.

X is carbon or nitrogen. However, if X is nitrogen, no R¹⁶ is present.

A metal complex formed by a metal and the compound represented by the formula (6) is preferably a boron complex represented by the following formula (7) or (8):

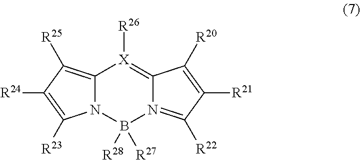

wherein R²⁰ to R²⁶ and X are the same as R¹⁰ to R¹⁶ and X in the formula (6). R²⁷ and R²⁸ are independently a halogen atom, a hydrogen atom, an alkyl group, an aryl group, a heterocyclic group, an alkoxy group, an aralkyl group, a carbocyclic aryl group or a heterocyclic aryl group.

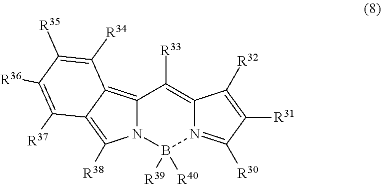

wherein R³⁰ to R³² and R³⁴ to R³⁸ are independently a hydrogen atom, an alkyl group, an alkoxyalkyl group, an alkoxy group, an alkoxyalkoxy group, an aryloxy group, an acyl group, an alkoxycarbonyl group, a dialkylaminocarbonyl group, an alkylcarbonylamino group, an arylcarbonylamino group, an arylaminocarbonyl group, an aryloxycarbonyl group, an aralkyl group, a carbocyclic aryl group, an alkenyloxycarbonyl group, an aralkyloxycarbonyl group, an alkoxycarbonylalkoxycarbonyl group, an alkylcarbonylalkoxycarbonyl group, a di(alkoxyalkyl)aminocarbonyl group or an alkenyl group.

R³³ is a hydrogen atom, a cyano group, an alkyl group, an aralkyl group, a carbocyclic aryl group, a heterocyclic aryl group or an alkenyl group.

R³⁹ and R⁴⁰ are independently fluorine, an alkyl group, an alkoxy group, an aralkyl group, a carbocyclic aryl group or a heterocyclic aryl group, and at least one of R³⁹ and R⁴⁰ is fluorine or an alkoxy group.

As specific examples of the compound having a pyrromethene skeleton represented by the formula (6) or a metal complex of the compound represented by the formula (6), the following can be given.

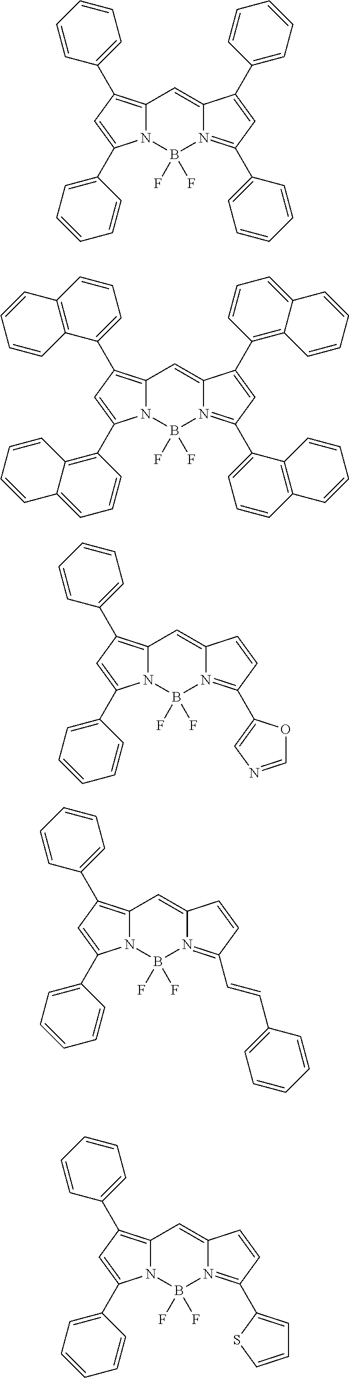

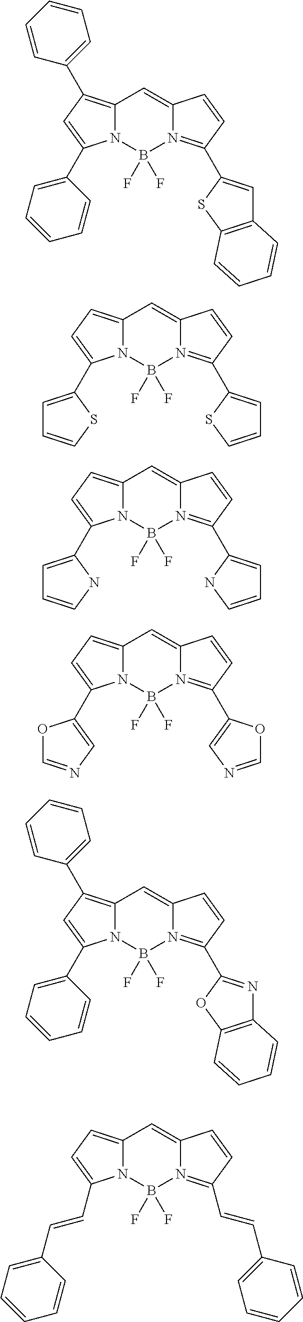

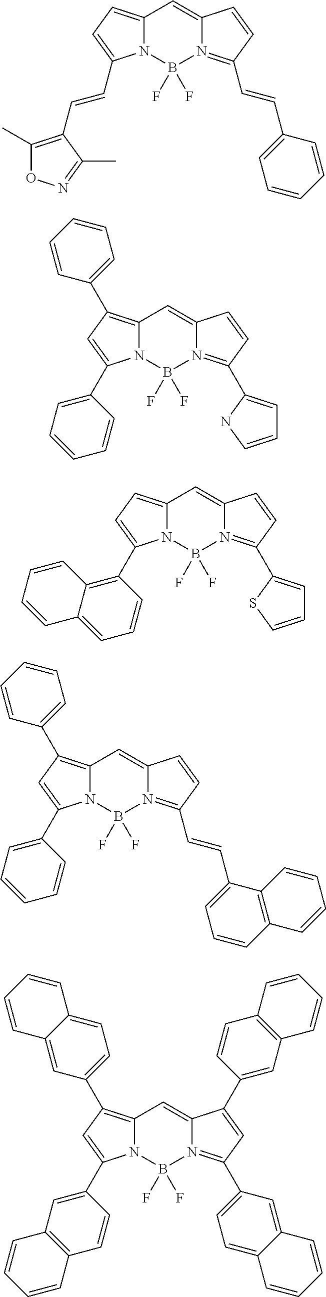

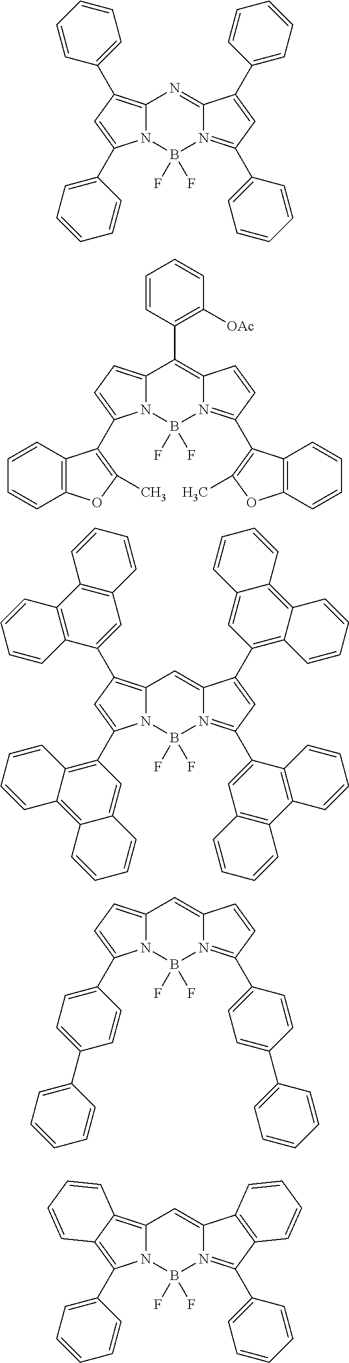

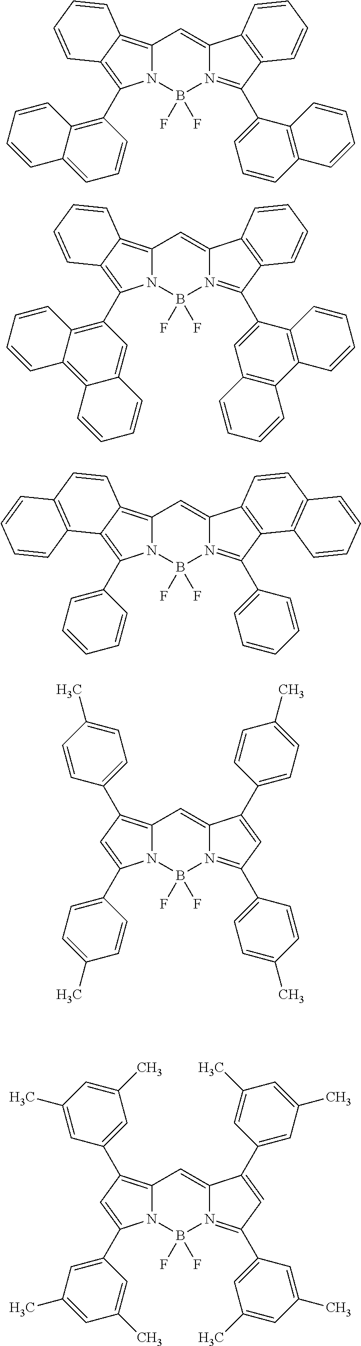

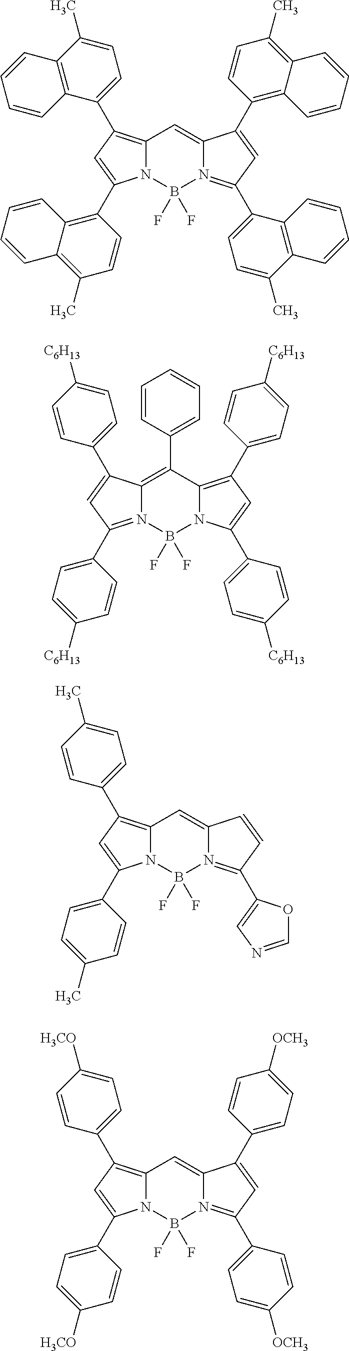

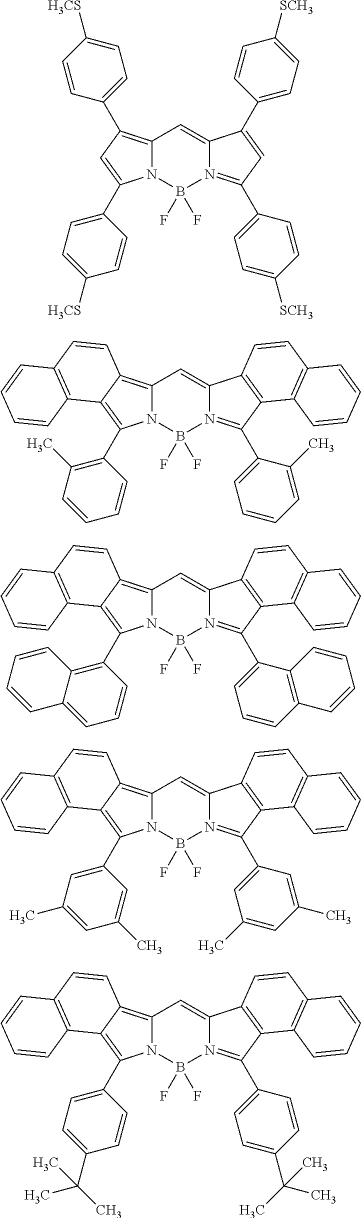

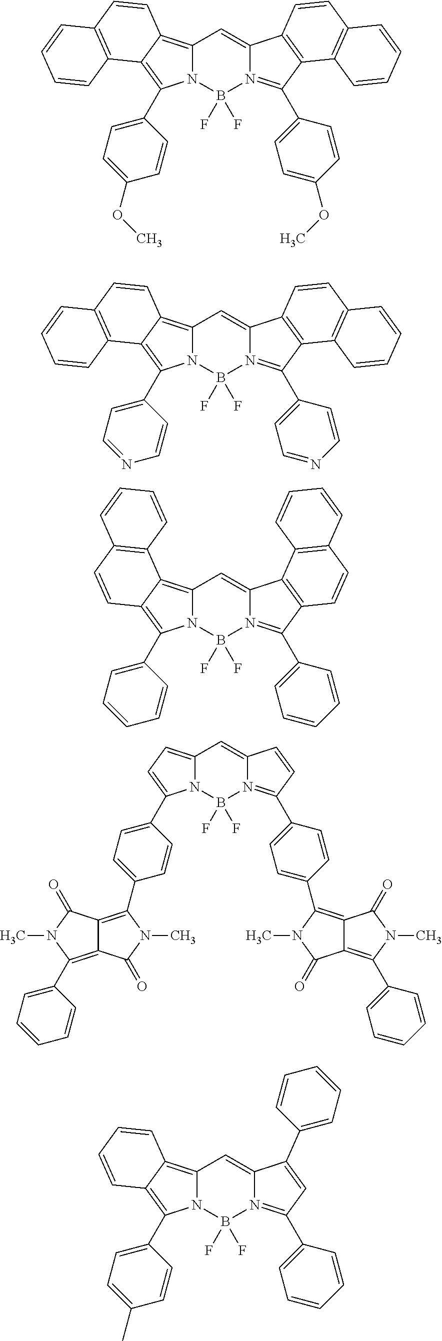

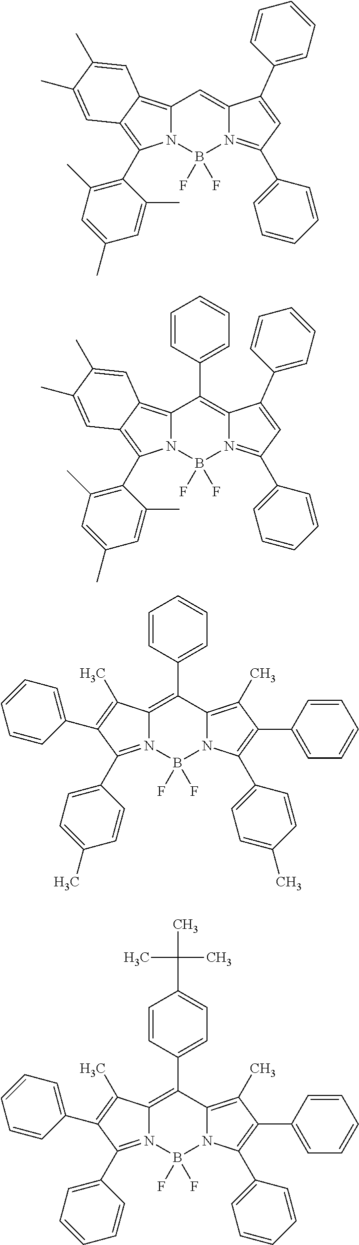

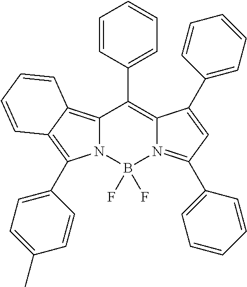

When the organic EL material composition of the invention contains a dopant, the content of a dopant is preferably 0.01 to 20 wt % of the host material.

The organic EL material composition of the invention may be composed essentially of the naphthacene derivative of the invention, the solvent of the invention, and, optionally, the dopant of the invention. The organic EL material composition of the invention may consist only of these components. The expression “composed essentially of” means that the above-mentioned composition is mainly composed of the naphthacene derivative of the invention, the solvent of the invention, and, optionally, the dopant of the invention, and may contain the following additives in addition to these components.

In the organic EL material composition of the invention, if necessary, a viscosity adjusting agent, an antioxidant, a light stabilizer, a polymerization inhibitor, a surface tension adjustment agent, a filler, a surfactant, an antifoaming agent, a leveling agent, an antistatic agent or the like may be added.

As a viscosity adjusting liquid, an alcohol-based solution, a ketone-based solution, a paraffin-based solution and an alkyl-substituted aromatic compound-based solution or the like can be given, for example, with an alcohol-based solution and an alkyl-substituted aromatic compound-based solution being preferable.

Examples of an alcohol-based solution include methanol, ethanol, propanol, butanol, pentanol, hexanol, octanol, nonanol, decanol, cyclohexanol, methylcellosolve, ethylcellosolve, ethylene glycol, propanediol, butanediol and benzyl alcohol. The above-mentioned alcohol may have a linear structure or a branched structure.

As the alkyl-substituted aromatic compound-based solution, linear or branched butylbenzene, dodecylbenzene, tetraline, cyclohexylbenzene, 1,1-bis(3,4-dimethylphenyl)ethane or the like can be given.

As the antioxidant, L-ascorbic acid (vitamin C), erythorbic acid (isoascorbic acid), catechin, tocopherol (vitamin E), BHT (dibutylhydroxytoluene), BHA (butylhydroxyanisole), sodium sulfite, sulfur dioxide, or the like can be given.

It is preferred that an antioxidant have a functional group selected from a group consisting of a phenol group, an aldehyde group, a phosphino group, a phosphite group, a thiol group, a dithio group, an amino group and an imino group.

As the light stabilizer (HALS), light stabilizers having a function of converting light energy to thermal energy or light stabilizers having a radical scavenging function can be given, for example. Both stabilizers have an effect of suppressing a lowering in fluorescent quantum yield or an effect of improving the stability of chromaticity. Of these light stabilizers, those having a radical scavenging function are particularly superior in the effect of improving these properties. Specifically, a hindered amine-based light stabilizer is preferable. Of these hindered amine-based light stabilizers, an alkoxyamine-based or an acetylated amine-based hindered amine-based light stabilizer is more preferable.

These additives (a viscosity adjusting agent, an antioxidant, a light stabilizer, a polymerization inhibitor, a surface tension adjustment agent, a filler, a surfactant, an antifoaming agent, a leveling agent, an antistatic agent or the like) may be used singly or may be used in combination with a plurality of additives differing in function or may be used in combination with a plurality of additives having the same function.

The organic EL material composition of the invention does not contain a solid or powdery material having a size of preferably 0.5 μm or more, more preferably 0.2 μm or more.

The method for preparing the organic EL material composition of the invention is not particularly restricted as long as it can mix the above-mentioned constituent materials and dissolve and disperse the mixture in a solvent.

It is preferable to prepare the organic EL material composition by the heating method, the reflux heating method, the pressure method, the agitation method, the ultrasonic irradiation method, the electromagnetic irradiation method, the beads mill dispersion method, the jet mill dispersion method, the oscillation method, or a combination of two or more of these.

The method for forming a thin film according to the invention will be explained.

In the method for forming a thin film according to the invention, the organic EL material composition of the invention is applied to a base to form a film thereon, followed by removal of a solvent, thereby to form a thin film.

As for the base to which the organic EL material composition is applied, a substrate of an organic EL device, organic thin film layers such as a hole-injecting layer, electrodes or the like, or the like can be given.

No particular restrictions are imposed on the method for applying and forming into a film of the organic EL material composition. Coating methods, such as the dipping method, the spin coating method, the casting method, the gravure coating method, the bar coating method, the slit coating method, the roll coating method, the dip coating method, the spray coating method, the screen printing method, the flexographic printing method, the offset printing method, the inkjet printing method and the nozzle jet printing method, can be used.

If an organic EL thin film is formed by the above-mentioned coating methods, it is preferred that the composition have a viscosity of several cP or more. In particular, if the organic EL material composition is applied by the ink-jet method, the viscosity of the solution is more preferably 6 cP or more, with 7 cP or more being further preferable. If the organic EL material is applied by the slit coating method or the like, the viscosity of the organic EL material composition is preferably several cP or less, with 3 cP or less being more preferable.

Since the organic EL material composition is often used for forming a thin film with a thickness of several ten nm, the upper limit of the viscosity thereof is about 100 cP, for example.

As for the method for removing the solvent, it is preferred that a solvent be removed by natural drying, drying by heating, drying under pressure or under reduced pressure, gas flow drying, or by combination of these removing methods.

The organic EL device obtained by using the organic EL material composition of the invention is, for example, a stacked body of organic thin film layers having respective functions, e.g. a hole-injecting layer/a hole-transporting layer/an emitting layer/an electron-transporting layer/an electron-injecting layer or the like. The emitting layer of the organic EL device is normally formed of a host material and a dopant material, and energy transfer or the like from the host material to the dopant material occurs, whereby the dopant material has a function of light emission.

In the emitting layer, a dopant material is added (doped) in a host material. Therefore, a host material constitutes a major part (80% or more, for example) of an emitting layer with a thickness of 30 nm to 100 nm, for example. Therefore, if an emitting layer is formed by a coating method, a predetermined amount of a host material is required to be dissolved in an organic EL material composition. Since the solvent of the organic EL composition of the invention can dissolve a naphthathene derivative as a host material at a desired concentration, it is possible to form an emitting layer into a film by a coating method.

There are no particular restrictions on the thickness of each of the organic thin film layers. The thickness is normally 10 to 100 nm, preferably 50 nm or more. If the thickness of the organic thin film layer is 50 nm or more, lowering of emission performance or significant shift in color tone can be prevented. If the film thickness is less than 10 nm, defects such as pinholes tend to occur easily, and if the film thickness exceeds 1 μm, for example, a high voltage is required to be applied, resulting in a poor efficiency.

### EXAMPLES

The invention will be explained with reference to Examples, which should not be construed as limiting the scope of the invention.

The host, dopant and polymer used in Examples and Comparative Examples are shown below.

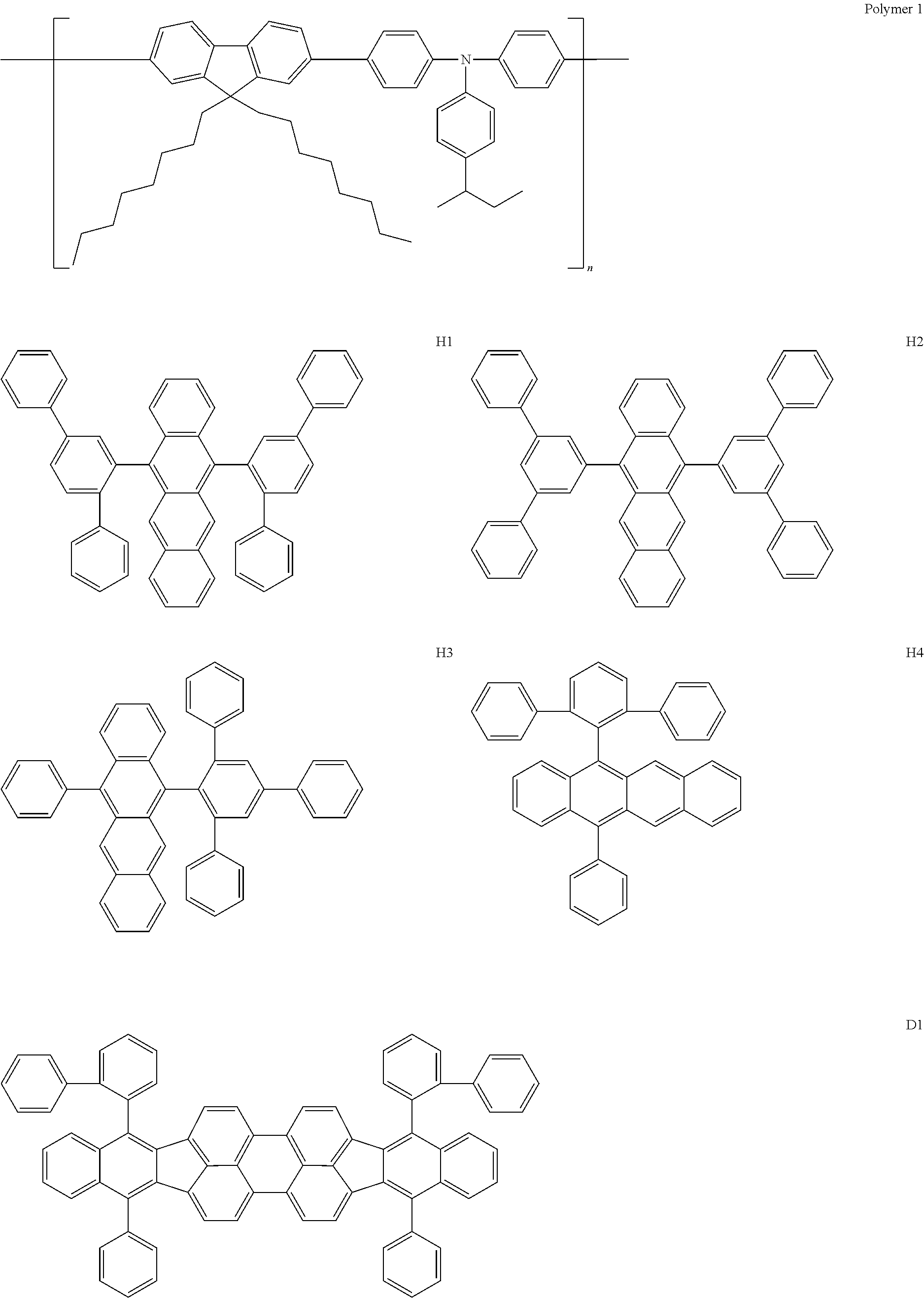

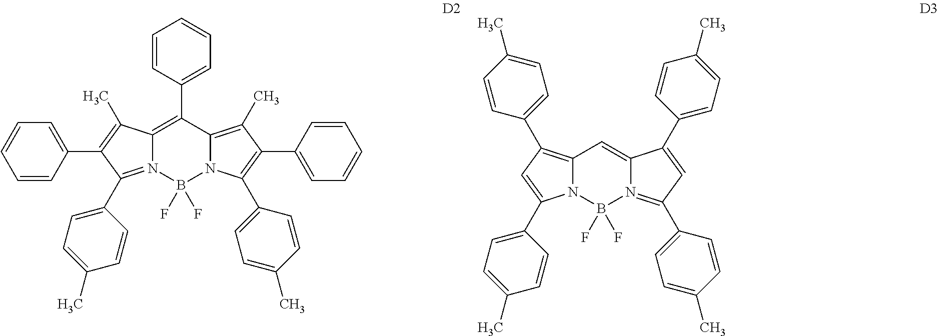

### Example 1

### (1) Preparation of an Organic EL Material Composition

0.1 g of the compound H1 and 10 g of indene were placed in a glass bottle, and stirred. As a result of visual observation of the glass bottle, it was confirmed that the compound H1 was completely dissolved in indene, with no remaining insoluble matters.

The compound D1 was further added to the above-mentioned indene solution of the compound H1, whereby an organic EL material coating liquid which is a 1 wt % indene solution containing the compound H1 and the compound D1 (the compound H1:the compound D1=100:1 (wt/wt)) was obtained.

### (2) Formation of a Coating Liquid

The ink as prepared above was applied on a 100 mm×100 mm×1.1 mm glass substrate by means of a baker applicator, followed by drying in vacuum. As a result of observation of a coating film thus formed, it was revealed that a uniform film without uneveness in film thickness was formed.

### (2) Fabrication of an Organic EL Device

A glass substrate of 100 mm by 100 mm by 1.1 mm thick with an ITO transparent electrode (GEOMATEC CO., LTD.) was subjected to ultrasonic cleaning with isopropyl alcohol for 5 minutes, and cleaned with ultraviolet rays and ozone for 30 minutes.

On the substrate, by means of a baker applicator, polyethylenedioxythiophene/polystyrene sulfonic acid (PEDOT:PSS) was formed into a film, whereby a hole-injecting layer with a film thickness of 100 nm was stacked.

Subsequently, a toluene solution (0.6 wt %) of the polymer 1 (Mw: 145000) was formed into a film by means of a baker applicator, followed by drying at 170° C. for 30 minutes, whereby a 20 nm-thick hole-transporting layer was stacked. Subsequently, by using the above-mentioned organic EL material coating liquid, a 50 nm-thick emitting layer was formed by means of a baker applicator. On the emitting layer, a 10 nm-thick tris(8-quinolinol)aluminum film (hereinafter abbreviated as the “Alq film”) was formed. This Alq film functions as an electron-transporting layer. Then, Li as a reductive dopant (Li source: manufactured by SAES Getters Co., Ltd.) and Alq were co-deposited, whereby an Alq:Li film was formed as an electron-injecting layer (cathode).

Metal aluminum was deposited on the Alq:Li film to form a metallic cathode, whereby an organic EL device was fabricated.

The organic EL device thus obtained emitted red light, and had uniform emission surface.

The “ink properties” in Table 1 shows the results of observing visibly whether there are insoluble matters in the composition thus prepared after the storage thereof at room temperature (around 20° C.) for two weeks. Coating liquids which were transparent having no insoluble matters were evaluated as good, and coating liquids containing insoluble matters were evaluated as poor.

### Comparative Example 1

A coating film and an organic EL device were prepared in the same manner as in Example 1, except that 3-ethyltoluene was used instead of indene as a solvent for an organic EL material coating liquid. The coating film thus obtained had an uneven surface, and hence had poor appearance. Further, the emission surface of the EL device was non-uniform. The results are shown in Table 1.

### Examples 2 to 60 and Comparative Examples 2 to 12

Organic EL material coating liquids were prepared and coating films were formed and evaluated in the same manner as in Example 1, except that the hosts, the dopants and the solvents shown in Tables 1 to 3 were used. The results are shown in Tables 1 to 3.

The solvent used in Example 4 and Examples 39 to 49 was a mixed solvent obtained by mixing indene and cyclohexanone at a weight ratio of 90:10.

When dodecylbenzene was used as the solvent, the ink could not be prepared since the host was not dissolved, and the ink properties were evaluated as “insoluble”.

When 3-ethyltoluene was used as the solvent, although the ink could be prepared, 3-ethyltoluene did not have solubility sufficient enough for forming a film by coating, and hence, precipitates were observed during the film formation process. Therefore, the coating film properties were evaluated as “poor”.

When 4-ethyltoluene was used as the solvent, insoluble matters were observed during the storage of the ink thus prepared. Therefore, the ink properties were evaluated as “poor”.

TABLE 1

| | | | | | Coating | Uniformity |
|---|---|---|---|---|---|---|
| | | | | Ink | film | of emission |
| | Host | Dopant | Solvent | properties | properties | surface |
| Example 1 | H1 | D1 | Indene | Good | Good | Uniform |
| Example 2 | H1 | D1 | Indane | Good | Good | Uniform |
| Example 3 | H1 | D1 | 2-Methylanisole | Good | Good | Uniform |
| Example 4 | H1 | D1 | Indene/ | Good | Good | Uniform |
| | | | Cyclohexanone | | | |
| Example 5 | H1 | D1 | 2-Ethyltoluene | Good | Good | Uniform |
| Example 6 | H2 | D1 | Indene | Good | Good | Uniform |
| Example 7 | H3 | D1 | Indene | Good | Good | Uniform |
| Example 8 | H4 | D1 | Indene | Good | Good | Uniform |
| Example 9 | H1 | D2 | Indene | Good | Good | Uniform |
| Example 10 | H2 | D2 | Indene | Good | Good | Uniform |
| Example 11 | H3 | D2 | Indene | Good | Good | Uniform |
| Example 12 | H4 | D2 | Indene | Good | Good | Uniform |
| Example 13 | H1 | D3 | Indene | Good | Good | Uniform |
| Example 14 | H2 | D3 | Indene | Good | Good | Uniform |
| Example 15 | H3 | D3 | Indene | Good | Good | Uniform |
| Example 16 | H4 | D3 | Indene | Good | Good | Uniform |
| Example 17 | H2 | D1 | Indane | Good | Good | Uniform |
| Example 18 | H3 | D1 | Indane | Good | Good | Uniform |
| Example 19 | H4 | D1 | Indane | Good | Good | Uniform |
| Example 20 | H1 | D2 | Indane | Good | Good | Uniform |
| Example 21 | H2 | D2 | Indane | Good | Good | Uniform |
| Example 22 | H3 | D2 | Indane | Good | Good | Uniform |
| Example 23 | H4 | D2 | Indane | Good | Good | Uniform |
| Example 24 | H1 | D3 | Indane | Good | Good | Uniform |
| Example 25 | H2 | D3 | Indane | Good | Good | Uniform |
| Example 26 | H3 | D3 | Indane | Good | Good | Uniform |
| Example 27 | H4 | D3 | Indane | Good | Good | Uniform |

TABLE 2

| | | | | | Coating | Uniformity |
|---|---|---|---|---|---|---|
| | | | | Ink | film | of emission |
| | Host | Dopant | Solvent | properties | properties | surface |
| Example 28 | H2 | D1 | 2-Methylanisole | Good | Good | Uniform |
| Example 29 | H3 | D1 | 2-Methylanisole | Good | Good | Uniform |
| Example 30 | H4 | D1 | 2-Methylanisole | Good | Good | Uniform |
| Example 31 | H1 | D2 | 2-Methylanisole | Good | Good | Uniform |
| Example 32 | H2 | D2 | 2-Methylanisole | Good | Good | Uniform |
| Example 33 | H3 | D2 | 2-Methylanisole | Good | Good | Uniform |
| Example 34 | H4 | D2 | 2-Methylanisole | Good | Good | Uniform |
| Example 35 | H1 | D3 | 2-Methylanisole | Good | Good | Uniform |
| Example 36 | H2 | D3 | 2-Methylanisole | Good | Good | Uniform |
| Example 37 | H3 | D3 | 2-Methylanisole | Good | Good | Uniform |
| Example 38 | H4 | D3 | 2-Methylanisole | Good | Good | Uniform |
| Example 39 | H2 | D1 | Indene/ | Good | Good | Uniform |
| | | | Cyclohexanone | | | |
| Example 40 | H3 | D1 | Indene/ | Good | Good | Uniform |
| | | | Cyclohexanone | | | |
| Example 41 | H4 | D1 | Indene/ | Good | Good | Uniform |
| | | | Cyclohexanone | | | |
| Example 42 | H1 | D2 | Indene/ | Good | Good | Uniform |
| | | | Cyclohexanone | | | |
| Example 43 | H2 | D2 | Indene/ | Good | Good | Uniform |
| | | | Cyclohexanone | | | |
| Example 44 | H3 | D2 | Indene/ | Good | Good | Uniform |
| | | | Cyclohexanone | | | |
| Example 45 | H4 | D2 | Indene/ | Good | Good | Uniform |
| | | | Cyclohexanone | | | |
| Example 46 | H1 | D3 | Indene/ | Good | Good | Uniform |
| | | | Cyclohexanone | | | |
| Example 47 | H2 | D3 | Indene/ | Good | Good | Uniform |
| | | | Cyclohexanone | | | |
| Example 48 | H3 | D3 | Indene/ | Good | Good | Uniform |
| | | | Cyclohexanone | | | |
| Example 49 | H4 | D3 | Indene/ | Good | Good | Uniform |
| | | | Cyclohexanone | | | |

TABLE 3

| | | | | | Coating | Uniformity |
|---|---|---|---|---|---|---|
| | | | | Ink | film | of emission |
| | Host | Dopant | Solvent | properties | properties | surface |
| Example 50 | H2 | D1 | 2-Ethyltoluene | Good | Good | Uniform |
| Example 51 | H3 | D1 | 2-Ethyltoluene | Good | Good | Uniform |
| Example 52 | H4 | D1 | 2-Ethyltoluene | Good | Good | Uniform |
| Example 53 | H1 | D2 | 2-Ethyltoluene | Good | Good | Uniform |
| Example 54 | H2 | D2 | 2-Ethyltoluene | Good | Good | Uniform |
| Example 55 | H3 | D2 | 2-Ethyltoluene | Good | Good | Uniform |
| Example 56 | H4 | D2 | 2-Ethyltoluene | Good | Good | Uniform |
| Example 57 | H1 | D3 | 2-Ethyltoluene | Good | Good | Uniform |
| Example 58 | H2 | D3 | 2-Ethyltoluene | Good | Good | Uniform |
| Example 59 | H3 | D3 | 2-Ethyltoluene | Good | Good | Uniform |
| Example 60 | H4 | D3 | 2-Ethyltoluene | Good | Good | Uniform |
| Com. Ex. 1 | H1 | D1 | 3-Ethyltoluene | Good | Poor | Non-uniform |
| Com. Ex. 2 | H1 | D1 | 4-Ethyltoluene | Poor | — | — |
| Com. Ex. 3 | H1 | D1 | Dodecylbenzene | Insoluble | — | — |
| Com. Ex. 4 | H2 | D1 | 3-Ethyltoluene | Good | Poor | Non-uniform |
| Com. Ex. 5 | H2 | D1 | 4-Ethyltoluene | Poor | — | — |
| Com. Ex.6 | H2 | D1 | Dodecylbenzene | Insoluble | — | — |
| Com. Ex. 7 | H3 | D1 | 3-Ethyltoluene | Good | Poor | Non-uniform |
| Com. Ex. 8 | H3 | D1 | 4-Ethyltoluene | Poor | — | — |
| Com. Ex. 9 | H3 | D1 | Dodecylbenzene | Insoluble | — | — |
| Com. Ex. 10 | H4 | D1 | 3-Ethyltoluene | Good | Poor | Non-uniform |
| Com. Ex. 11 | H4 | D1 | 4-Ethyltoluene | Poor | — | — |
| Com. Ex. 12 | H4 | D1 | Dodecylbenzene | Insoluble | — | — |

From Tables 1 to 3, it was revealed that the solvent having a specific structure has a sufficient solubility for a naphthacene derivative used as the red-emitting material, an indenoperylene derivative and a pyrromethene derivative. Further, it was revealed that, in the case of the organic EL material composition of the invention, the ink stability thereof was improved and a thin film obtained by using the ink was improved in flatness and uniformity, and the performance of the organic EL device was also good.

### INDUSTRIAL APPLICABILITY

The organic EL material composition can be preferably used as a coating liquid for forming organic thin film layers, especially an emitting layer, of an organic EL device.

The organic EL device of the invention can be suitably used as various displays, a light source such as a planar emitting material and backlight of a display, a display part of a portable phone, a PDA, a car navigation system, or an instrument panel of an automobile, an illuminator, and the like.

The contents of the above-mentioned documents are herein incorporated by reference in its entirety.

1. An organic electroluminescence material composition comprising an organic electroluminescence material and a solvent,
the organic electroluminescence material being a naphthacene derivative, and
the solvent being a solvent which is represented by the following formula (1): 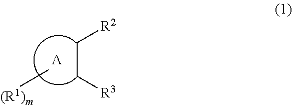
wherein the ring A is one selected from the group consisting of an aliphatic ring having 4 to 8 carbon atoms, an aromatic ring having 4 to 8 carbon atoms, a nitrogen-containing aliphatic ring having 4 to 8 carbon atoms, an oxygen-containing aliphatic ring having 4 to 8 carbon atoms and a sulfur-containing aliphatic ring having 4 to 8 carbon atoms;
R¹ is a substituent for the ring A, and is a hydrogen atom, a substituted or unsubstituted alkyl group having 1 to 10 carbon atoms, a substituted or unsubstituted cycloalkyl group, a substituted or unsubstituted alkoxy group having 1 to 10 carbon atoms, a substituted or unsubstituted aralkyl group having 6 to 10 carbon atoms, a substituted or unsubstituted aryloxy group having 5 to 10 ring atoms, a substituted or unsubstituted arylthio group having 5 to 20 ring atoms, a substituted or unsubstituted alkoxycarbonyl group having 1 to 10 carbon atoms, a substituted or unsubstituted silyl group, a carboxy group, a halogen atom, a cyano group, a nitro group or a hydroxyl group;
m is an integer of 1 to 6, and when m is an integer of 2 or more, plural R¹s may be the same or different;
R² and R³ are substituents bonded to adjacent carbon atoms on the ring A, and are independently an alkyl group having 1 to 10 carbon atoms, a substituted or unsubstituted alkenyl group having 1 to 10 carbon atoms, a substituted or unsubstituted cycloalkyl group, a substituted or unsubstituted cycloalkenyl group, a substituted or unsubstituted alkoxy group having 1 to 10 carbon atoms, a substituted or unsubstituted aralkyl group having 6 to 10 carbon atoms, a substituted or unsubstituted aryloxy group having 5 to 10 ring atoms, a substituted or unsubstituted arylthio group having 5 to 20 ring atoms, a substituted or unsubstituted alkoxycarbonyl group having 1 to 10 carbon atoms, a substituted or unsubstituted silyl group, a carboxyl group, a halogen atom, a cyano group, a nitro group, or hydroxyl group; and
R² and R³ may be bonded to each other to form a ring.

2. The organic electroluminescence material composition according to claim 1, wherein the ring A is a hydrocarbon ring having 6 carbon atoms.

3. The organic electroluminescence material composition according to claim 1, wherein R² and R³ of the solvent represented by the formula (1) are bonded to each other to form a ring; and
the substituent formed by bonding of R² and R³ is one of
a substituted or unsubstituted cycloalkylene group having 4 to 10 carbon atoms, a substituted or unsubstituted cycloalkenylene group having 4 to 10 carbon atoms, a substituted or unsubstituted cyclooxyalkylene group having 3 to 10 carbon atoms, a substituted or unsubstituted cyclooxyalkenylene group having 3 to 10 carbon atoms, a substituted or unsubstituted cyclothioalkylene group having 3 to 10 carbon atoms, a substituted or unsubstituted cyclothioalkenylene group having 3 to 10 carbon atoms, a substituted or unsubstituted cycloazaalkylene group having 3 to 10 carbon atoms, a substituted or unsubstituted cycloazaalkenylene group having 3 to 10 carbon atoms, a substituted or unsubstituted arylene group having 5 to 10 ring atoms, a substituted or unsubstituted oxyarylene group having 4 to 10 ring atoms, a substituted or unsubstituted thioarylene group having 4 to 10 ring atoms, and a substituted or unsubstituted azaarylene group having 3 to 10 ring atoms.

4. The organic electroluminescence material composition according to claim 1, wherein the naphthacene derivative has a molecular weight of 4000 or less.

5. The organic electroluminescence material composition according to claim 1, wherein the naphthacene derivative is a compound represented by the following formula (2): 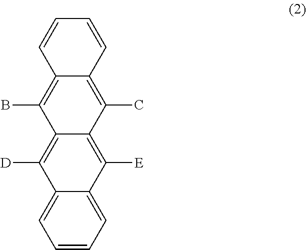
wherein B, C, D and E are independently a hydrogen atom, a substituted or unsubstituted aromatic group having 6 to 20 carbon atoms or a substituted or unsubstituted fused aromatic ring group having 10 to 20 carbon atoms.

6. The organic electroluminescence material composition according to claim 5, wherein at least one of B, C, D and E of the compound represented by the formula (2) is a substituent represented by the formula (3): 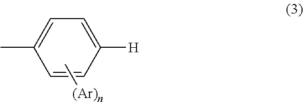
wherein Ar is a substituted or unsubstituted phenyl group, a substituted or unsubstituted naphthyl group or a substituted or unsubstituted biphenyl group;
n is an integer of 1 to 4, and when n is an integer of 2 or more, plural Ars may be the same or different; and
H is a hydrogen atom.

7. The organic electroluminescence material composition according to claim 1 which further comprises one or more dopants.

8. The organic electroluminescence material composition according to claim 7, wherein a dopant is an indenoperylene derivative represented by the following formula (4): 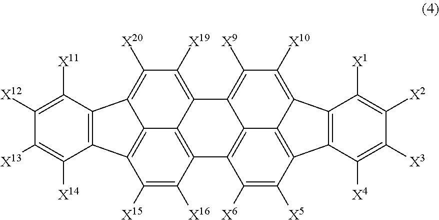
wherein X¹ to X⁶, X⁹, X¹⁰, X¹¹ to X¹⁶, X¹⁹ and X²⁰ are independently hydrogen, halogen, an alkyl group, an alkoxy group, an alkylthio group, an alkenyl group, an alkenyloxy group, an alkenylthio group, an aromatic ring-containing alkyl group, an aromatic ring-containing alkyloxy group, an aromatic ring-containing alkylthio group, an aromatic ring group, an aromatic heterocyclic group, an aromatic ring-oxy group, an aromatic ring-thio group, an aromatic ring alkenyl group, an alkenyl aromatic ring group, an amino group, a carbazolyl group, a cyano group, a hydroxy group, —COOR^{1′} (R^{1′} is hydrogen, an alkyl group, an alkenyl group, an aromatic ring-containing alkyl group or an aromatic ring), —COR^{2′} (R^{2′} is hydrogen, an alkyl group, an alkenyl group, an aromatic ring-containing alkyl group, an aromatic ring group or an amino group), or —OCOR^{3′} (R^{3′} is an alkyl group, an alkenyl group, an aromatic ring-containing alkyl group or an aromatic ring group);
adjacent substituents of X¹ to X⁶, X⁹, X¹⁰, X¹¹ to X¹⁶, X¹⁹ and X²⁰ may be bonded together to form a ring; and
compounds in which all of X¹ to X⁶, X⁹, X¹⁰, X¹¹ to X¹⁶, X¹⁹ and X²⁰ are hydrogen are excluded.

9. The organic electroluminescence material composition according to claim 8, wherein the indenoperylene derivative represented by the formula (4) is an indenoperylene derivative represented by the following formula (5): 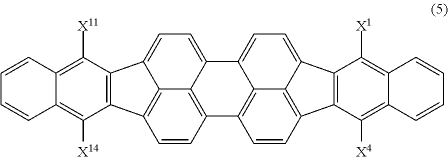
wherein X¹, X⁴, X¹¹ and X¹⁴ are the same as those in the formula (4).

10. The organic electroluminescence material composition according to claim 7, wherein a dopant is a compound having a pyrromethene skeleton represented by the following formula (6) or a metal complex of at least one metal selected from the group consisting of boron, beryllium, magnesium, chromium, iron, cobalt, nickel, copper, zinc and platinum and a compound represented by the formula (6): 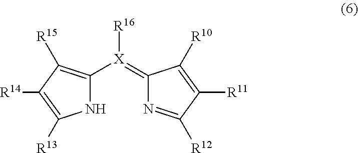
wherein R¹⁰ to R¹⁶ are independently hydrogen, an alkyl group having 1 to 20 carbon atoms, a cycloalkyl group having 1 to 20 carbon atoms, an aralkyl group having 1 to 20 carbon atoms, an alkenyl group having 1 to 20 carbon atoms, a cycloalkenyl group having 1 to 20 carbon atoms, an alkynyl group having 1 to 20 carbon atoms, a hydroxy group, a mercapto group having 1 to 20 carbon atoms, an alkoxy group having 1 to 20 carbon atoms, an alkylthio group having 1 to 20 carbon atoms, an arylether group having 1 to 20 carbon atoms, an arylthioether group having 1 to 20 carbon atoms, an aryl group having 1 to 20 carbon atoms, a heterocyclic group having 1 to 20 carbon atoms, halogen, a haloalkyl group having 1 to 20 carbon atoms, a haloalkenyl group having 1 to 20 carbon atoms, a haloalkynyl group having 1 to 20 carbon atoms, a cyano group, an aldehyde group having 1 to 20 carbon atoms, a carbonyl group having 1 to 20 carbon atoms, a carboxyl group having 1 to 20 carbon atoms, an ester group having 1 to 20 carbon atoms, a carbamoyl group having 1 to 20 carbon atoms, an amino group, a nitro group, a silyl group or a siloxanyl group, R¹⁰ to R¹⁶ may be bonded to adjacent substituents to form a fused ring or an aliphatic ring;
at least one of R¹⁰ to R¹⁶ contains an aromatic ring or forms a fused ring with an adjacent substituent; and
X is carbon or nitrogen, provided that if X is nitrogen, no R¹⁶ is present.

11. The organic electroluminescence material composition according to claim 10, wherein the metal complex is a boron complex represented by the following formula (7) or (8): 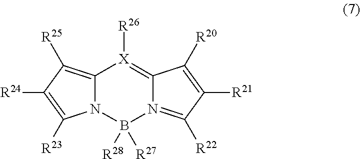
wherein R²⁰ to R²⁶ and X are the same as R¹⁰ to R¹⁶ and X in the formula (6); and
R²⁷ and R²⁸ are independently a halogen atom, a hydrogen atom, an alkyl group, an aryl group, a heterocyclic group, an alkoxy group, an aralkyl group, a carbocyclic aryl group or a heterocyclic aryl group. 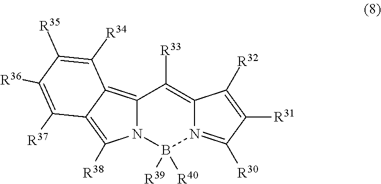
wherein R³⁰ to R³² and R³⁴ to R³⁸ are independently a hydrogen atom, an alkyl group, an alkoxyalkyl group, an alkoxy group, an alkoxyalkoxy group, an aryloxy group, an acyl group, an alkoxycarbonyl group, a dialkylaminocarbonyl group, an alkylcarbonylamino group, an arylcarbonylamino group, an arylaminocarbonyl group, an aryloxycarbonyl group, an aralkyl group, a carbocyclic aryl group, an alkenyloxycarbonyl group, an aralkyloxycarbonyl group, an alkoxycarbonylalkoxycarbonyl group, an alkylcarbonylalkoxycarbonyl group, a di(alkoxyalkyl)aminocarbonyl group or an alkenyl group;
R³³ is a hydrogen atom, a cyano group, an alkyl group, an aralkyl group, a carbocyclic aryl group, a heterocyclic aryl group or an alkenyl group; and
R³⁹ and R⁴⁰ are independently fluorine, an alkyl group, an alkoxy group, an aralkyl group, a carbocyclic aryl group or a heterocyclic aryl group, and at least one of R³⁹ and R⁴⁰ is fluorine or an alkoxy group.

12. A method for forming a thin film of an organic electroluminescence material which comprises applying on a base the organic electroluminescence material composition according to claim 1; and removing a solvent from the organic electroluminescence material composition on the base to form a thin film of an organic electroluminescence material.

13. A thin film of an organic electroluminescence material obtained by using the organic electroluminescence material composition according to claim 1.

14. An organic electroluminescence device which comprises the organic electroluminescence material thin film according to claim 13.
